(19) United States
(12) Patent Application Publication
(10) Pub. No.: US 2022/0294244 A1
(43) Pub. Date: Sep. 15, 2022

(54) SYSTEMS AND METHODS FOR CHARGING VEHICLE ACCESSORY

(71) Applicant: TOYOTA MOTOR ENGINEERING & MANUFACTURING NORTH AMERICA, INC., PLANO, TX (US)

(72) Inventor: SEAN L. HELM, Saline, MI (US)

(21) Appl. No.: 17/196,769

(22) Filed: Mar. 9, 2021

(51) Int. Cl. H02J 7/00; B60L 1/00

(52) U.S. Cl. CPC H02J 7/0048; H02J 7/007194; B60L 1/00; H02J 2310/54

(57) ABSTRACT

Methods of charging accessory devices to vehicles can maximize the lifespan of rechargeable batteries. A method executed at a processor of a vehicle can include determining a charging time for an accessory to a vehicle based on anticipated demand of the accessory device, determining vehicle operational information comprising driving characteristics, and dynamically charging the accessory device based on the determined vehicle operational information and the charging time for the accessory to the vehicle.

### TECHNICAL FIELD

The present disclosure relates generally to charging vehicle accessories.

### DESCRIPTION OF RELATED ART

Currently, to charge a vehicle accessory at or by a vehicle, charging of the accessory is scheduled at the accessory.

### BRIEF SUMMARY OF THE DISCLOSURE

According to various embodiments of the disclosed technology, the disclosed embodiments may provide systems and methods for maximizing the lifespan of rechargeable batteries in removable vehicle components. According to various embodiments of the disclosed technology, the disclosed embodiments may provide systems and methods for dynamically charging rechargeable accessory devices based on determined vehicle operational information and the charging time for the accessory device.

A method executed at a processor of a vehicle can include determining a charging time for an accessory to a vehicle based on anticipated demand of the accessory device. The method can further include determining vehicle operational information comprising driving characteristics for the vehicle. The method can further include dynamically charging the accessory device based on the determined vehicle operational information and the charging time for the accessory to the vehicle. The method can further include determining accessory device specific information and charging the accessory device according to a need of the accessory device. The vehicle operational information can further include at least one of vehicle specific information, contextual information related to the vehicle or driver specific information. The accessory device can be charged based on an estimated use of the accessory device by a specific driver or occupant of the vehicle. As such, determining charging time for the accessory to the vehicle can include determining the use of the accessory device by a specific drive or occupant of the vehicle. Charging the accessory device based on the determined vehicle operational information and the charging time for the accessory to the vehicle can include charging the accessory device based on a determined route for the vehicle. Determining the vehicle operational information can include determining driving specific information. The driving specific information can further include determining an estimated arrival time at which the vehicle will arrive at a destination. The driving specific information can further include determining an estimated arrival time at which the vehicle will arrive at a portion of the route where the device is expected to be used. The method can further include determining that the charging time for the accessory to the vehicle is less than or equal to an estimated time to the destination and charging the accessory device. The method can further include determining that the charging time for the accessory to the vehicle is greater than or equal to an estimated time to the destination and not immediately charging the accessory device. The method can further include determining that the charging time for the accessory to the vehicle is greater than or equal to an estimated time to the destination and charging the accessory device to a first state of charge threshold.

The method can further include determining that the charging time for the accessory to the vehicle is less than an estimated time to the destination and charging the accessory device to a second state of charge threshold. Charging the accessory based on the determined vehicle operational information can include deciding to defer charging of the accessory until a predicted time to a destination less the determined charging time. Determining a charging time for an accessory to a vehicle can include determining a predicted use of the accessory device.

The method can further include detecting that the vehicle is traversing a route previously traversed. The method can further include determining that the accessory device is not usually removed from the charger during that specific route. The method can further include charging the device to a state of charge threshold while the vehicle is on that route. In embodiments of the method, the device is only charged if the state of charge of a battery of the vehicle that is used to charge the accessory device is at or above a threshold. In embodiments of the method, the accessory device is only charged a temperature of the accessory device is below a temperature threshold. In embodiments of the method, the accessory device is only charged if a state of charge of a battery of the accessory device is below a state of charge threshold. In embodiments, the

[symbol]

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example vehicle with which embodiments of the systems and methods disclosed herein may be implemented.

FIG. 2 illustrates an example architecture for detecting and charging an accessory in accordance with various embodiments of the systems and methods described herein.

FIG. 3 Illustrates an example architecture of an accessory charging system in accordance with various embodiments of the systems and methods described herein.

FIG. 4A illustrates a diagram of method for charging a battery of an accessory to a vehicle according to aspects of the present disclosure.

FIG. 4B illustrates another diagram of method for charging a battery of an accessory to a vehicle according to aspects of the present disclosure that delay charging.

FIG. 4C illustrates yet another diagram of method for charging a battery of an accessory to a vehicle according to aspects of the present disclosure.

FIG. 4D illustrates yet another diagram of method for charging a battery of an accessory to a vehicle according to aspects of the present disclosure.

FIG. 4E illustrates yet another diagram of method for charging a battery of an accessory to a vehicle according to aspects of the present disclosure and toggling between charging states.

FIG. 5 is an example computing component that may be used to implement various features of embodiments described in the present disclosure.

The figures are not exhaustive and do not limit the present disclosure to the precise form disclosed.

### DETAILED DESCRIPTION

People use various devices with internal batteries in their daily life, some of which are associated with vehicle use. Accordingly, embodiments of the systems and methods disclosed herein enable charging of vehicle accessories with internal batteries according to the specific needs of the accessory device, in view of vehicle and/or driving specific information. Further, disclosed is a vehicle accessory charging system that can anticipate the demand or use for an accessory device. Vehicle operation as well as accessory device use can be dynamic. Accordingly, the disclosed accessory charging system can enable charging of a vehicle accessory device with dynamic and/or automatic adjustment of one or more aspects of charging. The disclosed vehicle accessory charging system can anticipate the demand or use for the accessory device in view of one or more vehicle operational information, such as vehicle specific and/or driving specific information. The system can accomplish this by accessory charging circuit that includes an accessory detection circuit and a charge control circuit.

Some batteries require specific charging profiles, for example to maximize battery life span (e.g. prevent and/or minimize reduction of capacity over time and/or with each cycle), prevent or minimize stress on the battery, and/or prevent and/or minimize overcharging. The specific best practices and charging profiles may depend on the type and/or chemistry of the battery cell, as well as the expected use. Various battery chemistries may include Li-ion, Li-Polymer, NiMH, NiCd, NiZn, and NiH2, etc.

Various intended uses of the batteries may depend on the specific device with which they are integrated. For example, some devices may be single use (e.g. emergency systems), and some others may be used for hundreds, if not thousands of cycles. Some devices may be used (i.e. discharged) sparingly (e.g. only in case of emergencies, once every month, year, decade, etc.), while others multiple times per day. As another example, the charging profile, as well as the discharge rate and/or depth of discharge may depend on the specific use and/or accessory device they are integrated with. For example some devices require low (e.g. sensors), medium (e.g. consumer devices), and/or high (e.g. appliances, power tools) discharge rates.

It may be beneficial for some batteries to be charged at different rates (e.g. current level), depending on voltage level and/or state of charge. For example, it could be beneficial for some cells to charge at a higher rate if SOC is between 45%-75%, but a lower rate (e.g. trickle charging) if SOC is between 85%. For some batteries, it may be recommended that the never go above or below a specific SOC. It is understood that that various charging profiles can be incorporated into the present disclosure, and can depend on various charging parameters. These charging parameters can be battery specific such as battery chemistry, capacity, thermal capacity, charging cycle, battery voltage, capacity, discharge rate, depth of discharge, etc. These charging parameters can be device and/or use specific, such as life time, intended cycles, discharge rate, etc. Accordingly, embodiments of the systems and methods disclosed herein enable charging of accessory devices according to the specific needs of the battery and/or device.

These devices can be vehicle accessories, and/or be integrated within vehicle accessory devices or systems. Vehicle accessory devices can be devices that can be and/or are intended to be used in the vehicle or outside the vehicle (e.g. at a destination). As such, they may be removable from the vehicle. As such, the accessory devices may require a certain state of charge before and/or while they are used. These devices may be used outside of the vehicle, and they may require a certain level of charge for their use.

Accessories disclosed herein can include various devices that are intended to be used by occupants, users, operators (human, robotic or otherwise) of the vehicle. The accessories can also facilitate a goal of the vehicle itself. These device can be used in relation to a specific purpose of the vehicle. For example, if the vehicle is a service vehicle, the device can be related to performance of the specific service. For example, the device can include power equipment (drills, jump starters, lifts, etc.) for a vehicle intended to be used in connection with servicing other vehicles. The devices can include radios, safety equipment, life support devices, etc. in connection with emergency vehicles. The accessory devices can include other vehicles, such as drones or robots. For example, vehicles can contain one or more drones or robots capable of performing tasks (such as surveying, delivery, exploration, sensing, firefighting, etc.). Other devices can include personal devices, such as mobile phones, personal hotspots, laptops, tablets, gaming equipment, or other consumer electronics. The device can include, for example recreational equipment such towed recreational vehicles.

These devices can also be used within on or outside the vehicle. For example, various consumer devices can be used by occupants of the vehicle, such as phones or tables. Other examples include radios, medical devices (e.g. to be used by first responders or medical personal within an ambulance). As another example, the devices can include one or more sensors (e.g. tire pressure sensors), airbag systems, ejection seats (e.g. for sports vehicles or aircraft) etc.

It would be advantageous if these devices could remain charged (i.e. with a certain state of charge (SOC), for example, between some percentage level between zero and maximum or 100% of a capacity) while they are used and intended to be used. For some devices, it is not convenient to charge while the devices are being used. While wireless charging is becoming ubiquitous, even these technologies require the device to be within some distance from a charger. Meanwhile, people commute and/or travel for certain hours a day in their vehicles. It would be convenient to charge accessory devices while driving and/or commuting, so that these accessory devices can be charged and ready to be used at the destination (i.e. outside of the vehicle). Further, it would be advantageous if the device were in a convenient location in proximity to a charger (because it is necessarily within the vehicle).

Conventional vehicle accessory charging does not optimize charging for specific battery needs of the accessory device (i.e. to benefit the battery and/or the intended use or user), and based on vehicle operational information, such as vehicle, environmental, and/or driving specific information which is unique to the vehicle environment and context.

Before describing embodiments of the disclosed system and methods in detail, it is useful to describe example vehicles that the disclosed systems and methods can be implemented with. The systems and methods disclosed herein may be implemented with any of a number of different vehicles and vehicle types. These can be gasoline- or diesel-powered vehicles, hybrid, fuel-cell vehicles, electric vehicles, or other vehicles. The systems and methods disclosed herein may be used with automobiles, trucks, motorcycles, recreational vehicles and other like on- or off-road vehicles. In addition, the principals disclosed herein may also extend to other vehicle types as well, such as aerial (e.g. aircraft, drones) and/or submersible (e.g. watercraft, boats) vehicles.

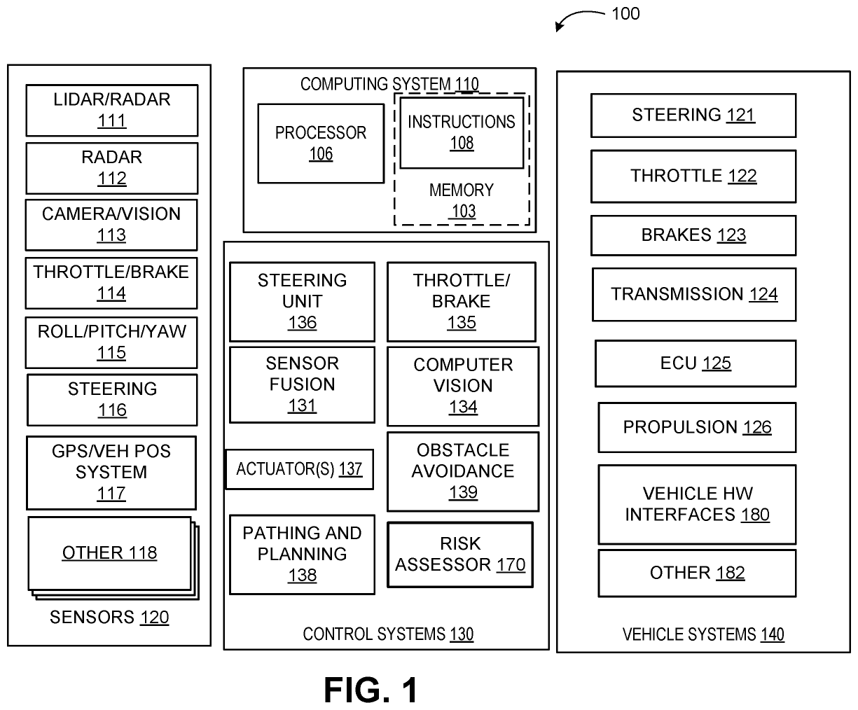

An example vehicle in which embodiments of the disclosed technology may be implemented is illustrated in FIG. 1.

Vehicle 100 and the vehicle 100 components includes a computing system 110, sensors 120, Control systems, 130 and vehicle systems 140.

Vehicle 100 may include a greater or fewer quantity of systems and subsystems and each could include multiple elements. Accordingly, one or more of the functions of the technology disclosed herein may be divided into additional functional or physical components, or combined into fewer functional or physical components. Additionally, although the systems and subsystems illustrated in FIG. 1 are shown as being partitioned in a particular way, the functions of vehicle 100 can be partitioned in other ways. For example, various vehicle systems and subsystems can be combined in different ways to share functionality.

Either of the computing system 110, sensors 120, control systems 130, and/or vehicle systems 130 can be part of an automated vehicle system/advanced driver assistance system (ADAS). Although a vehicle with automated vehicle system/advanced driver assistance system (ADAS) is described it is understood that the vehicles without ADAS can employ the technologies discloses herein. ADAS can provide navigation control signals (e.g. control signals to actuate the vehicle and/or operate one or more vehicle systems 140 as shown in FIG. 1 for the vehicle to navigate a variety of situations. As used herein, ADAS can be an autonomous vehicle control system adapted for any level of vehicle control and/or driving autonomy. For example, the ADAS can be adapted for level 1, level 2, level 3, level 4, and/or level 5 autonomy. ADAS can allow for control mode blending (i.e. blending of autonomous and/or assisted control modes with human driver control). ADAS can correspond to a real-time machine perception system.

Sensors 120 may include a plurality of different sensors to gather data regarding vehicle 100, its operator, its operation, and/or its surrounding environment. Sensors can be configured to generate one or more signals that correspond to information about vehicle operational information (e.g. information about the vehicle, the environment, the context, and/or driving information). This information can be as operational information, vehicle state information, contextual information (i.e. the vehicle in context with external surroundings) and/or driving specific information (e.g. that relate to one or more driving parameters, such as destination, path, corridor, driver/operator state) driving as well as driving characteristics. Vehicle information can relate to one or more states of the vehicle systems (including vehicle, operational, and/or external information), such as battery SOC, the level of vehicle autonomy, traffic conditions, the state of one or more traffic lights. Driving specific information can relate to one or more information that could ultimately affect the driving path of the vehicle, time to destination and/or waypoint, and can be vehicle, operational, and/or external information. In this sensors 120 include light detection and ranging (LiDAR) sensor 111, radar 112, or other like the distance measurement sensors, image sensors 113, throttle and brake sensors 114, 3D accelerometers 115, steering sensors 116, and a GPS or other vehicle positioning system 117. One or more of the sensors 120 may gather data and send that data to the vehicle ECU or other processing unit. Sensors 120 (and other vehicle components) may be duplicated for redundancy.

Distance measuring sensors such as LiDAR sensor 111, radar 112, IR sensors and other like sensors can be used to gather data to measure distances and closing rates to various external objects such as other vehicles, traffic signs, pedestrians, light poles and other objects. Image sensors 111 can include one or more cameras or other image sensors to capture images of the environment around the vehicle as well as internal to the vehicle. Information from image sensors 113 (e.g. camera) can be used to determine information about the environment surrounding the vehicle 100 including, for example, information regarding other objects surrounding vehicle 100. For example, image sensors 113 may be able to recognize landmarks or other features (including, e.g., street signs, traffic lights, etc.), slope of the road, lines on the road, curbs, objects to be avoided (e.g., other vehicles, pedestrians, bicyclists, etc.) and other landmarks or features. Information from image sensors 113 can be used in conjunction with other information such as map data or information from positioning system 117 to determine, refined or verify vehicle location.

Throttle and brake sensors 114 can be used to gather data regarding throttle and brake application by a human or autonomous operator. Accelerometers 115 may include a 3D accelerometer to measure roll, pitch and yaw of the vehicle. Accelerometers 115 may include any combination of accelerometers and gyroscopes for the vehicle or any of a number of systems or subsystems within the vehicle to sense position and orientation changes based on inertia.

Steering sensors 116 (e.g., such as a steering angle sensor) can be included to gather data regarding steering input for the vehicle by a human or autonomous operator. A steering sensor may include a position encoder monitor the angle of the steering input in degrees. Analog sensors may collect voltage differences that can be used to determine information about the angle and turn direction, while digital sensors may use an LED or other light source to detect the angle of the steering input. A steering sensor may also provide information on how rapidly the steering wheel is being turned. A steering wheel being turned quickly is generally normal during low-vehicle-speed operation and generally unusual at highway speeds. If the driver is turning the wheel at a fast rate while driving at highway speeds the vehicle computing system may interpret that as an indication that the vehicle is out of control. Steering sensor 116 may also include a steering torque sensor to detect an amount of force the driver is applying to the steering wheel.

Vehicle positioning system 117 (e.g., GPS or other positioning system) can be used to gather position information about a current location of the vehicle as well as other positioning or navigation information.

Other sensors 118 may be provided as well. Other sensors 118 can include vehicle acceleration sensors, battery SOC monitor (e.g. for an electric or hybrid vehicle), vehicle speed sensors, wheelspin sensors (e.g. one for each wheel), a tire pressure monitoring sensor (e.g. one for each tire), vehicle clearance sensors, left-right and front-rear slip ratio sensors, and/or environmental sensors (e.g. to detect weather, traction conditions, or other environmental conditions. Other sensors 118 can include sensors within a cabin of the vehicle, such as sensors that detect one or more passengers in a cabin of the vehicle and/or sensors that detect one or more devices (e.g. the accessory devices described herein) within the vehicle (e.g. in the cabin). Eye state tracking, occupancy sensors, such as strain gauges in the vehicle seats, and/or door sensors may be used to determine to gather information about the driver and/or occupants. Other sensors 118 can detect one or more connected devices within and/or on the vehicle. Various sensors 120, such as other sensors 118 may be used to provide input to computing system 110, vehicle systems 130, control system 130, and other systems of vehicle 100 so that the systems have information useful to operate in an autonomous, semi-autonomous and/or manual mode. In one embodiment, sensors 120 may be included to detect one or more conditions directly or indirectly such as, for example, propulsion efficiency motor efficiency, EMG, hybrid (internal combustion engine) efficiency), fuel efficiency, battery SOC, mileage, speed, acceleration, ACC, emissions, occupancy, conditions of the environment, manifold temperature/pressure, air temperature, coolant temperature, throttle position, oxygen levels, adaptive fuel, engine cylinder fire/misfire, injection system flow, evaporative emissions, exhaust gas recirculation, mass airflow, gas cap state, the open or close state of one or more doors or other openings of the vehicle 100, etc.

In some embodiments, one or more of the sensors 120 may include their own processing capability to compute the results for additional information that can be provided to other systems, such as other sensors 120, control systems 130, vehicle systems 140. In other embodiments, one or more sensors may be data-gathering-only sensors that provide only raw data to electronic control unit 50. In further embodiments, hybrid sensors may be included that provide a combination of raw data and processed data to electronic control unit 50. Sensors 120 may provide an analog output or a digital output.

It can be understood that sensors 120 may be included to detect vehicle conditions, such as steering 116, throttle/brake 114 sensors, but also to detect external conditions as well. Sensors that might be used to detect external conditions can include, for example, sonar, radar 112, lidar 111 or other vehicle proximity sensors, and cameras 113 or other image sensors. Image sensors can be used to detect, for example, parking spots, other vehicles, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

Control systems 130 may include a plurality of different systems/subsystems to control operation of vehicle 100. In this example, control systems 130 can include autonomous driving module (not shown), steering unit 136, throttle and brake control unit 135, sensor fusion module 131, computer vision module 134, pathing and/or planning module 138, obstacle avoidance module 139, risk assessment module 170 and actuator(s) 137. Sensor fusion module 131 can be included to evaluate data from a plurality of sensors, including sensors 120. Sensor fusion module 131 may use computing system 110 or its own computing system to execute algorithms to assess inputs from the various sensors.

Throttle and brake control unit 135 can be used to control actuation of throttle and braking mechanisms of the vehicle to accelerate, slow down, stop or otherwise adjust the speed of the vehicle. For example, the throttle unit can control the operating speed of the engine or motor used to provide motive power for the vehicle. Likewise, the brake unit can be used to actuate brakes (e.g., disk, drum, etc.) or engage regenerative braking (e.g., such as in a hybrid or electric vehicle) to slow or stop the vehicle.

Steering unit 136 may include any of a number of different mechanisms to control or alter the heading of the vehicle. For example, steering unit 136 may include the appropriate control mechanisms to adjust the orientation of the front or rear wheels of the vehicle to accomplish changes in direction of the vehicle during operation. Electronic, hydraulic, mechanical or other steering mechanisms may be controlled by steering unit 136.

Computer vision module 134 may be included to process image data (e.g., image data captured from image sensors 113, or other image data) to evaluate the environment within or surrounding the vehicle. For example, algorithms operating as part of computer vision module 134 can evaluate still or moving images to determine features and landmarks (e.g., road signs, traffic lights, lane markings and other road boundaries, etc.), obstacles (e.g., pedestrians, bicyclists, other vehicles, other obstructions in the path of the subject vehicle) and other objects. The system can include video tracking and other algorithms to recognize objects such as the foregoing, estimate their speed, map the surroundings, and so on.

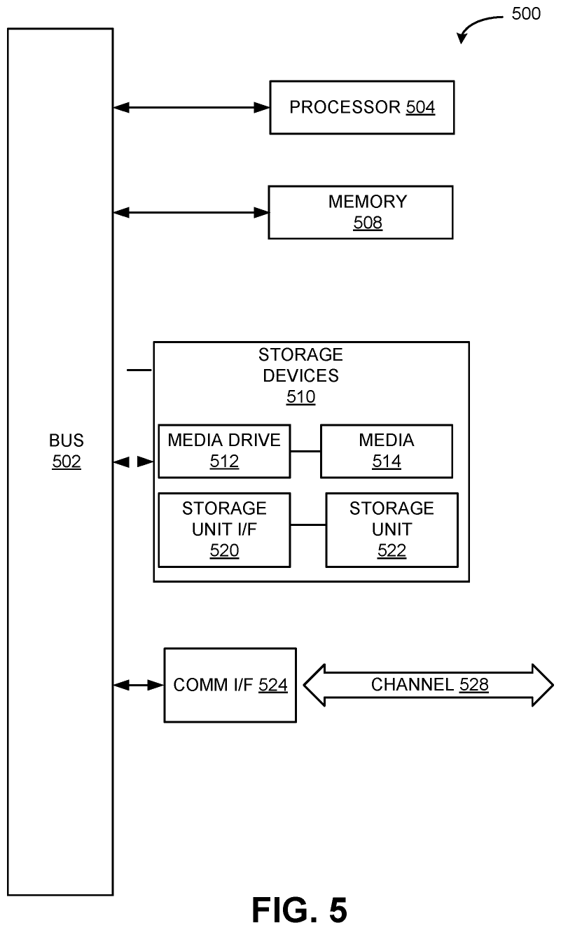

Pathing and/or planning module 138 may be included to compute a desired path for vehicle 100 based on input from various other sensors and systems. Input can also be provided one or more interface devices, such as a various driver interfaces. For example, pathing and planning module 138 can use information from positioning system 117, sensor fusion module 131, computer vision module 134, and/or obstacle avoidance module 139 (described below) and other systems (e.g. control systems 130, sensors 120, and/or vehicle systems 140) to determine an expected path or route to a destination, the time to a destination (or to an expected location of where the accessory device is to be used) or estimated time of arrival. Further, pathing and planning module may be able to communicated with one or more of the aforementioned interfaces (described in detail in FIG. 5), to receive input from a user, and/or operator of the vehicle regarding one or more destinations and/or way points. Pathing and planning module may determine how to navigate the vehicle along a segment of a desired route. Pathing module 138 may also be configured to dynamically update the vehicle path as real-time information is received from sensors 120, vehicle systems 140, other control systems 130, and/or the aforementioned interfaces (e.g. based on waypoints and/or destinations).

Obstacle avoidance module 139 can be included to determine control inputs necessary to avoid obstacles detected by sensors 120 or control systems 130. Obstacle avoidance module 139 can work in conjunction with pathing and planning module 138 to determine an appropriate path to avoid a detected obstacle, and the aforementioned time of arrival can appropriately be updated.

Pathing and planning module 138 (either alone or in conjunction with one or more other module of control system 130, such as obstacle avoidance module 139, computer vision module 134, and/or sensor fusion module 131) may also be configured to perform and/or coordinate one or more vehicle maneuver. Example vehicle maneuvers can include at least one of a corridor keeping, path tracking, stabilization, or collision avoidance maneuver. It is understood that control systems 130 can include other systems such as assist circuit(s) such as automated vehicle systems/advanced driver assistance systems (ADAS) adapted for any level of vehicle control and/or driving autonomy; perception systems, such as machine perception systems, which can include one or more computer vision 134 or machine vision or recognition systems.

Vehicle systems 140 may include a plurality of different systems/subsystems to control operation of vehicle 100. In this example, vehicle systems 130 can include steering system 121, throttle system 122, brakes 123, transmission 124, electronic control unit (ECU) 125 and propulsion system 126 (e.g. a motor and/or internal combustion engine), and vehicle hardware interfaces 180. These vehicle systems 140 may be controlled by control systems 130 in autonomous, semi-autonomous and/or manual mode. For example, in autonomous or semi-autonomous mode, control systems 130, alone or in conjunction with other systems, can control vehicle systems 140 to operate the vehicle in a fully or semi-autonomous fashion. When control is assumed, computing system 110 and/or control system 130 can provide vehicle control systems to vehicle hardware interfaces for controlled systems such as steering angle 121, brakes 123, throttle 122, or other hardware interfaces 180 such as traction force, turn signals, horn, lights, etc. This may also include an assist mode in which the vehicle takes over partial control or activates ADAS controls (e.g. control systems 130) to assist the driver with vehicle operation.

Vehicle systems 140 may include other systems 182. For example, they can include torque splitters which can control distribution of power among the vehicle wheels such as, for example, by controlling front/rear and left/right torque split; cooling systems 178 to provide cooling for the motors, power electronics, the engine, the cabin, or other vehicle systems; suspension system such as, for example, an adjustable-height air suspension system; and other vehicle systems.

Computing system 110 in the illustrated example includes a processor 106, and data storage or memory 103. Some or all of the functions of vehicle 100 may be controlled by computing system 110. Processor 106 can include one or more GPUs, CPUs, microprocessors or any other suitable processing system. Processor 106 may include one or more single core or multicore processors. Processor 106 executes instructions 108 stored in a non-transitory computer readable medium, such as memory 103.

Memory 103 may contain instructions (e.g., program logic) executable by processor 106 to execute various functions of vehicle 100, including those of vehicle systems and subsystems. Memory 103 may contain additional instructions as well, including instructions to transmit data to, receive data from, interact with, and/or control one or more of the sensors 120, control systems 130 and vehicle systems 140. In addition to the instructions, memory 103 may store data and other information used by the vehicle and its systems and subsystems for operation, including operation of vehicle 100 in the autonomous, semi-autonomous or manual modes. For example, memory 103 can include mapping data, vehicle dynamics data, computer vision recognition data, and/or other data which can be useful for the execution of one or more vehicle maneuvers, for example by one or more modules of the control systems 130.

Although one computing system 110 is illustrated in FIG. 1, in various embodiments multiple computing systems 110 can be included. Additionally, one or more systems and subsystems of vehicle 100 can include its own dedicated or shared computing system 110, or a variant thereof. Accordingly, although computing system 110 is illustrated as a discrete computing system, this is for ease of illustration only, and computing system 110 can be distributed among various vehicle systems 140. Control systems 130, sensors 120, or other components.

Vehicle 100 may also include a (wireless or wired) communication system (not illustrated) to communicate with other vehicles, devices (such as accessory devices as described herein), infrastructure elements, networks, servers, cloud components and other external entities using any of a number of communication protocols including, for example, V2V, V2I and V2X protocols. Such a wireless communication system may allow vehicle 100 to receive information from other objects including, for example, map data, data regarding infrastructure elements, traffic data, weather data, data regarding operation and intention of surrounding vehicles, and so on. For example, it can be understood that wireless communication system may allow the vehicle to receive information that may be useful in gauging a time to a destination and/or an time to an expected use of the accessory device. A wireless communication system may allow vehicle 100 to receive updates to data that can be used to execute one or more vehicle control modes, and/or vehicle control algorithms as discussed herein. Wireless communication system may also allow vehicle 100 to transmit information to other devices, infrastructure, and/or objects. In some applications, computing functions for various embodiments disclosed herein may be performed entirely on computing system 110, distributed among two or more computing systems 110 of vehicle 100, performed on a cloud-based platform, performed on an edge-based platform, or performed on a combination of the foregoing.

Communication system can be configured to receive data and other information from sensors 120 that is used in determining whether and to what extent control mode blending should be activated. Additionally, communication system can be used to send an activation signal or other activation information to various vehicle systems 140 and/or Control systems 130 as part of controlling the vehicle. For example, communication system can be used to send signals to one or more of the vehicle actuators 137 to control parameters, for example, maximum steering angle, throttle response, vehicle braking, torque vectoring, and so on.

Pathing and/or planning module 138 can allow for executing one or more vehicle control mode(s), and/or vehicle control algorithms in accordance with various implementations of the systems and methods disclosed herein.

In operation, path and planning module 138 (e.g. by a driver intent estimation module, not shown) can receive information regarding human control input used to operate the vehicle. As described above, information from sensors 120, actuators 137 and other systems can be used to determine the type and level of human control input. Path and planning module 138 can use this information to predict driver action. As also described above, information from sensors other systems can be used to determine the state of the driver, other occupants of the vehicle, and/or devices within the vehicle. Eye state tracking, for example, can be used to estimate driver state. Occupancy sensors, such as strain gauges in the vehicle seats, and/or door sensors may be used to determine driver state and other information. This information can be provided to a risk assessment module 170 to determine the level of risk associated with vehicle operation. Although not illustrated in FIG. 1, where the assessed risk is above a determined threshold, a warning signal can be provided to a driver interface to alert the driver (e.g., audibly or visually) of the risk. This information may be provided to other vehicle system 140, for example pathing and planning module 138 to determine.

Path and planning module 138 can receive state information such as, for example from visibility maps and hazard maps and local map views, and/or other mapping data. Information from a navigation system and/or from a driver/operation and/or occupant (e.g. by an interface) can also provide a mission plan, including maps and routing to path and planning module 138.

The path and planning module 138 can receive various information and predict behavior and/or navigation characteristics within a future time horizon. The path and planning module 138 can receive various information and predict behavior and/or navigation characteristics for specific drivers. For example, the information can be useful in estimating a time of arrival to a destination and/or waypoint. This information can be used by path and planning module 138 for executing one or more planning decisions and/or determining charging profiles for accessory device as disclosed herein Planning decisions can be based on one or more policy (such as defensive driving policy).

Path and planning module 138 can receive risk information from risk assessment module 170. Path and planning module 138 can receive vehicle capability and/or capacity information from one or more vehicle systems 140. Vehicle capability can be assessed, for example, by receiving information from vehicle hardware interfaces 180 to determine vehicle capabilities and identify a reachable set model. Path and planning module 138 can receive surrounding environment information (e.g. from computer vision module 134, and/or obstacle avoidance module 139), and/or sensors 120. Path and planning module 138 can apply risk information and/or vehicle capability and/or capacity information to trajectory information (e.g. based on a planned trajectory and/or driver intent) to determine a safe or optimized trajectory for the vehicle. This trajectory information can be provided to controller to provide partial or full vehicle control.

As alluded to above, vehicle 100 may include an electronic control unit 125, which can be implemented as one or more control circuits. Electronic control unit 125 may include circuitry to control various aspects of the vehicle operation. Electronic control unit 125 may include, for example, a microcomputer that includes a one or more processing units (e.g., microprocessors), memory storage (e.g., RAM, ROM, etc.), and I/O devices. The processing units of electronic control unit 125, execute instructions stored in memory to control one or more electrical systems or subsystems in the vehicle. Electronic control unit 125 can include a plurality of electronic control units such as, for example, an electronic engine control module, a powertrain control module, a transmission control module, a suspension control module, a body control module, and so on. As a further example, electronic control units can be included to control systems and functions, such as vehicle hardware interfaces 180, doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, ECU 125 receives information from a plurality of sensors 120 included in vehicle 100. For example, electronic control unit 125 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the propulsion system 125 (e.g. motor rotational speed), battery SOC, and vehicle speed.

As alluded to above, various embodiments enable accessories in vehicles to be charged at or by the vehicle. Charging of accessories, in accordance with one embodiment, may comprise detecting that an accessory device requires charging. Detection that the accessory device requires charging can activate an accessory charging mode at the vehicle. Thus, in embodiments, activation of the charging mode at the vehicle can enable charging of the accessory device according to aspects of the present disclosure. For example, it can enable charging according to one or more charging profiles.

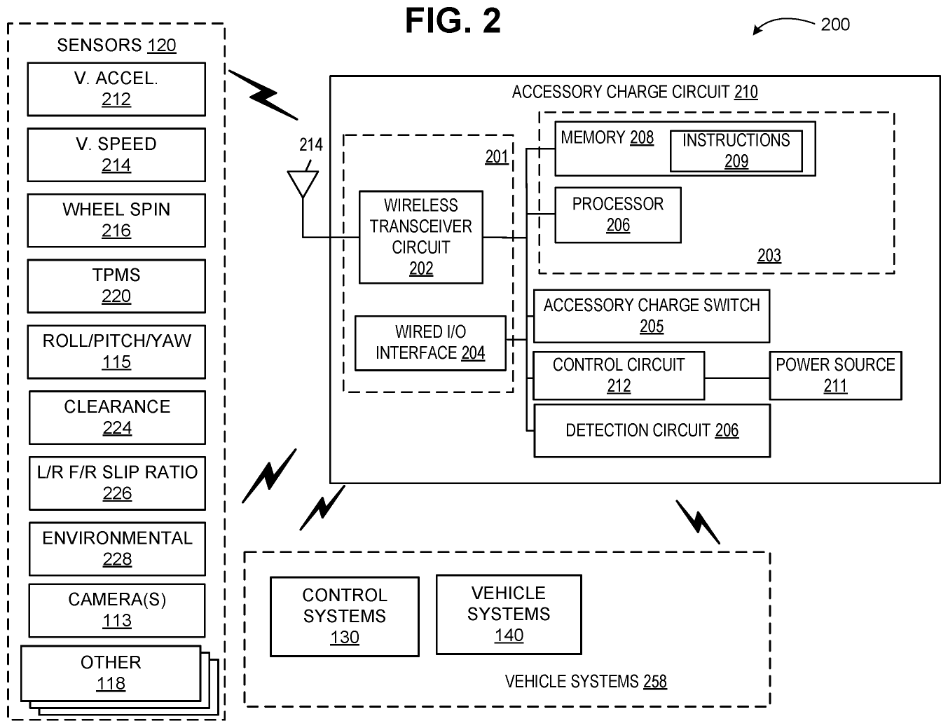

FIG. 2 illustrates an example architecture for detecting and charging an accessory, and entering into a an accessory charge mode in accordance with various embodiments of the systems and methods described herein. Detection of an accessory and/or entering into an accessory charging mode can indicate a need for the vehicle accessory to be charged. Referring now to FIG. 2, in this example, an accessory charging system 200 includes an accessory charge circuit 210, a plurality of sensors 120, and a plurality of vehicle systems 258. Accessory charging system 200 can be implemented as and/or include one or more components of the vehicle 100 shown in FIG. 1. Sensors 120 and vehicle systems 258 can communicate with the accessory charge circuit 210 via a wired or wireless communication interface. Although sensors 120 and vehicle systems 258 are depicted as communicating with accessory charge circuit 210, they can also communicate with each other, as well as with other vehicle systems. Accessory charge circuit 210 can be implemented as an ECU or as part of an ECU such as, for example electronic control unit 125. In other embodiments, accessory charge circuit 210 can be implemented independently of the ECU, for example, as another vehicle system.

Accessory charge circuit 210 can be configured to activate and/or detect a vehicle accessory in need of charge. Accessory charge circuit 210 in this example includes a communication circuit 201, a decision circuit 203 (including a processor 206 and memory 208 in this example), a power source 211 (which can include power supply), charge or power control circuit 212, and detection circuit 206. Power supply can include one or more regulators, converters, transformers, etc. Accessory charge circuit 210 can include one or more power coupling interfaces (not shown) to engage with an accessory device. These can include wired connections, such as USB-connection, and/or wireless power sources. These coupling interfaces can be included and/or include in wired and/or wireless interfaces (such as wireless transceiver 202 and/or wired I/O interface 204). The accessory can be power and/or communication can be provided by the same and/or different interfaces such that communication is in-band and/or out-of-band with the power. These interfaces can support one or more standard and/or non-standard charging standards (such as Quick Charge 2.0, Quick Charge 3.0, USB 3.1, and/or wireless standards such as AirFuel, and/or Qi) and/or connection standards (such as USB). These interfaces and accessory charge circuit 210 can support wired, wireless (near-field, far field, and other, e.g. acoustic/piezo electric/microwave) charging. It is understood that the disclosed accessory charge circuit 210 can be compatible with and support one or more standard or non-standard charging methodologies, and can charge one or more accessory devices.

Components of accessory charge circuit 210 are illustrated as communicating with each other via a data bus, although other communication in interfaces can be included. Accessory charge circuit 210 in this example also includes an accessory charge switch 205 that can be operated by the user to manually engage charging or activate a charge mode. As alluded to above, accessory charge circuit 210 includes a detection circuit 206. Detection circuit 206 may be configured to detect an accessory device is connected or otherwise coupled for charging. The accessory device can be detected by included mechanical and/or electrical detection. Detection circuit 206 can include one or more sensors. For example, the accessory device can be detected based on an established connection to wired i/o interface 204, and/or a wireless transceiver circuit 202. It can be understood that accessory charge circuit 210 can be configured to detect that the accessory device is inside and/or proximal to the vehicle (such as within an immediate vicinity to the vehicle). Detection circuit 206 can detect that the accessory device is a certain distance from an interface of the accessory charge circuit 210 (such as directly aligned with and coupled). The detection circuit 206 can determine that the accessory device is electrically and/or mechanically coupled to a charging interface the accessory charge circuit 210.

Control circuit 212 can be configured to control one or more aspects of charging. Control circuit can include one or more aspects of charging. Control circuit 212 can be configured to control charging of the accessory according to the appropriate time, current, voltage, and/or charging profile to charge the accessory device battery.

Processor 206 can include a GPU, CPU, microprocessor, or any other suitable processing system. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions 209 that may be used by the processor 206 to execute one or more functions of accessory charge circuit 210. For example, data and other information can include data related to charging, vehicle specific and/or device specific information as disclosed herein. Data can include driver and/or occupant specific information. The information can be stored according to one or more profiles, for example device specific profiles, route specific profiles, driver specific profiles, environmental specific profiles (e.g. based on traffic conditions, weather), and/or occupant specific profiles. Operational instruction 209 can contain instructions for executing logical circuits, and/or methods as described herein.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up an accessory charge circuit 210. Components of decision circuit 203 can be distributed among two or more decision circuits 203, performed on other circuits described with respect to accessory charge circuit 210, be performed on accessory devices (not shown) performed on a cloud-based platform, performed on an edge-based platform, and/or performed on a combination of the foregoing.

Communication circuit 201 either or both a wireless transceiver circuit 202 with an associated antenna 214 and a wired I/O interface 204 with an associated hardwired data port (not illustrated). As this example illustrates, communications with accessory charge circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by accessory charge circuit 210 to/from other components of the vehicle, such as sensors 120, vehicle systems 258, infrastructure (e.g. servers cloud based systems), and/or other devices, such as accessory devices described herein. These RF signals can include information of almost any sort that is sent or received by the accessory device being charged. These RF signals can assist the accessory charge circuit 210 in detecting the accessory device.

Wired I/O interface 204 can include a transmitter and a receiver (not shown) for hardwired communications with other devices. For example, wired I/O interface 204 can provide a hardwired interface to other components, including sensors 120, vehicle systems 258, and/or accessory device. Wired I/O interface 204 can communicate with other devices using Ethernet or any of a number of other wired communication protocols whether standardized, proprietary, open, point-to-point, networked or otherwise.

Power source 211 such as one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, another vehicle battery, alternator, etc.), an energy harvester (e.g., solar cells, piezoelectric system, etc.), or it can include any other suitable power supply. It is understood power source 211 can be coupled to a power source of the vehicle, such as a battery and/or alternator. Charge/control circuit 212 can be configured to control one or more aspects of power supply. Charge/control circuit 112 controls charging of an accessory device (e.g. by power source 211, and/or by charging interfaces (not shown, but can include portions of communication circuit 201). Charge/control circuit 112 control charging of an accessory device according to one or more charging profiles, including based on accessory device specific information (such as a charging time), and/or vehicle operational information (such as vehicle, environment, and/or driving specific information). As such, it is understood that the power source 211 and related control 212 can be used to power the accessory charge circuit 210. It is also understood that power source 211 and control circuit 212 can be used to power one or more devices, such as an accessory device as described herein.

Sensors 120 can include one or more of the previously mentioned sensors 120. It Sensors 120 can include one or more sensors that may or not otherwise be included on a standard vehicle (e.g. vehicle 100) with which the accessory charge circuit 210 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, environmental sensors 228 (e.g., to detect salinity or other environmental conditions), and camera(s) 213 (e.g. front rear, side, top, bottom facing). Additional sensors 118 can also be included as may be appropriate for a given implementation of accessory charging system 200.

Vehicle systems 158 can include any of a number of different vehicle components or subsystems used to control or monitor various aspects of the vehicle and its performance. For example, it can include any or all of the aforementioned vehicle systems 140 and/or control systems 130 shown in FIG. 1. In this example, the vehicle systems 158 include a GPS or other vehicle positioning system 172.

During operation, accessory charge circuit 210 can receive information from various vehicle sensors 152 and/or vehicle systems 158 to determine whether the to begin charging, and to determine a charging profile. For example, the charging mode can be activated to indicate one or more faults in vehicle systems 158. Also, the driver, owner, and/or operator of the vehicle may manually activate the charging mode by operating mode switch 105. Communication circuit 101 can be used to transmit and receive information between accessory charge circuit 210, sensors 152, accessory charge circuit 210 and/or vehicle systems 158. Also, sensors 152 and/or accessory charge circuit 210 may communicate with vehicle systems 158 directly or indirectly (e.g., via communication circuit 101 or otherwise). Communication circuit 101 can be used to transmit and receive information between accessory charge circuit 210, one or more other systems of a vehicle 100, but also other vehicles, devices (e.g. mobile phones), systems, networks (such as a communications network and/or central server), and/or infrastructure. For example, via communication circuit 110, accessory charge switch 105 can be activated and/or deactivated by receipt of a command from a central server, infrastructure and/or another device (such as accessory device).

In various embodiments, communication circuit 101 can be configured to receive data and other information from sensors 120 and/or vehicle systems 258 that is used in determining whether and how to charge the accessory. This data and information can relate to vehicle operational information (such as vehicle, contextual, and/or driving specific information). Vehicle information can relate to one or more states of the vehicle systems, such as battery SOC. Contextual and/or environmental information can relate to information regarding the surrounding environment (e.g. weather, road quality, traffic patterns) or vehicle context (such as that the vehicle is in a specific traffic pattern). Driving specific information can relate to one or more information that could ultimately affect the driving path (such as a state of the driver, a destination, a waypoint, driving habits, driving characteristics, environmental or contextual information associated to driving). It is understood that driving specific information can also include one or more vehicle, contextual, and/or environmental information. Additionally, communication circuit 101 can be used to send signals or and/or receive signals from various vehicle systems 258. For example, as described in more detail below, communication circuit 101 can be used to send and/or receive signals from sensors 120 and/or vehicle systems. Examples of this are described in more detail below. As another example, detecting an accessory (e.g. by detection circuit 205 and/or activation by accessory charge switch 205), communication circuit 101 can be used to send an activation signal and/or activation information to one or more vehicle systems 258 for the vehicle to provide certain information. Alternatively, accessory charge circuit 210 can be continuously receiving information from vehicle system 258, sensors 120, other devices and/or infrastructure. As alluded to above, this information can include vehicle, driving, and/or accessory device specific information. Further, during activation of charge mode the communication circuit 101 can send a signal to other components of the vehicle, infrastructure, and/or an accessory device based on the status of charging. For example, the communication circuit 101 can send a signal that charging has completed.

The examples of FIGS. 1 and 2 are provided for illustration purposes only as examples of vehicles and accessory charging system 200 with which embodiments of the disclosed technology may be implemented. One of ordinary skill in the art reading this description will understand how the disclosed embodiments can be implemented with vehicle platforms.

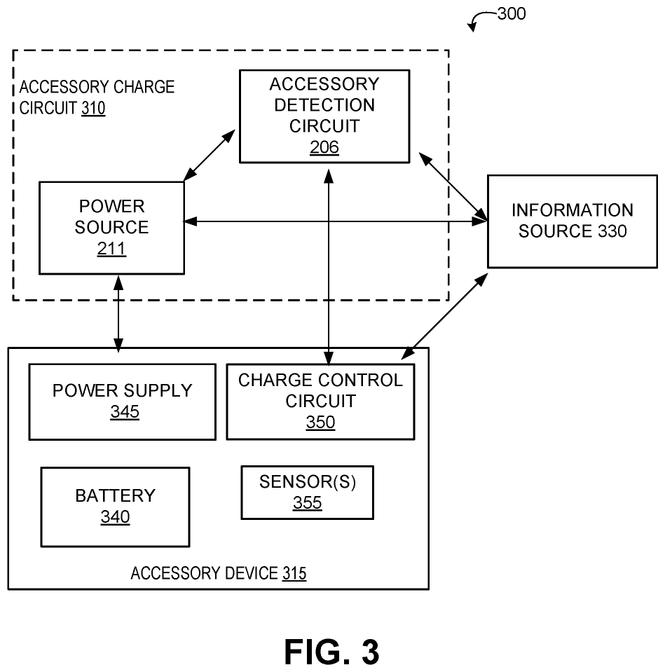

As previously discussed, detecting an accessory device and/or charging an accessory device (e.g. by accessory charge circuit 210) can indicate a need to charge the accessory device. As alluded to above, various embodiments enable vehicle accessories to be charged. FIG. 3 shows an example battery charging system 300 including an accessory charge circuit 310, accessory device 315, and information source 330.

The accessory charge circuit 310 can include one or more components of accessory charge circuit 210 shown in FIG. 2, such as accessory detection circuit 206, power source 211, control circuit 212, etc. It is understood that although power source 211 is shown part of accessory charge circuit 310, it can also be separate to it.

The battery charging system 300 can be used to detect an accessory device 315 to be charge, and charge the device according to one or more aspects described herein. For example, it can determine the appropriate time and/or charging profile for charging the battery, and charge the device accordingly. The appropriate time and/or charging profile can be based on accessory device specific formation, and/or vehicle operational information (such as vehicle, accessory, and/or driving specific information). Inputs from one or more information source 330 can be used to determine the appropriate time and/or charging profile for charging the battery. Inputs from information source 330 can be binary (on/off) input and/or analog input. Inputs from information source 330 could be a communication bus with message frames being processed by the accessory device 315 and/or the accessory charge circuit 310. Inputs from the information source 330 can include accessory device 315 specific information, and/or vehicle operational information (such as vehicle and/or driving specific information). Inputs from information source can be used to update one or more profiles as discussed herein. For example, inputs from the information source could be used to update a driver profile associated with a driver and their driving habits.

For example, information from information source 330 can include information from sensors 120, vehicle system 258 shown in FIG. 2, other components of vehicle 100 shown in FIG. 1, and/or from one or more server or other infrastructure. For example, driving specific information can include pathing and/or navigation planning information as determined by pathing and/or planning module 138. The input from information source 330 can include information such as an expected time of arrival to a destination. The information source 330 can include data from a power source 178 (shown here as part of accessory charge circuit 310, but it is understood that it can be separate), an accessory connection/detection mechanism, a temperature sensor as well as information about the driving conditions. The inputs can be used to judge and/or compare with one or more charging conditions or thresholds.

Accessory device 315 can include one or more components for executing functions of the accessory device, as well as components include a power supply 345, battery 340, charge control circuit 350, and/or sensor(s) 355. Sensor(s) 355 can include sensors to detect value(s) for one or more device parameters that could affect charging, such as temperature, voltage, current, GPS, the type of the device, device usage (e.g. by memory, battery drain, applications used, etc.). It is understood that sensor(s) 355 can provide information to charge control circuit 350, and/or to accessory charge circuit 310 (e.g. as an information source 330).

Power supply 345 can include one or more regulators, converters, transformers, etc. For example, these can limit the power to and/or from battery 340. Charge control circuit 350 can similarly control one or more aspects of charging the battery 340. It is understood that charge control circuit 350 can control aspects of charging similar to (and/or by command from) accessory charge circuit 210 (e.g. control circuit 212).

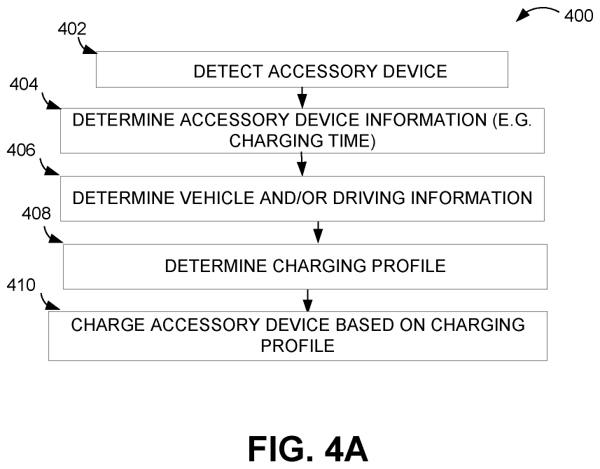

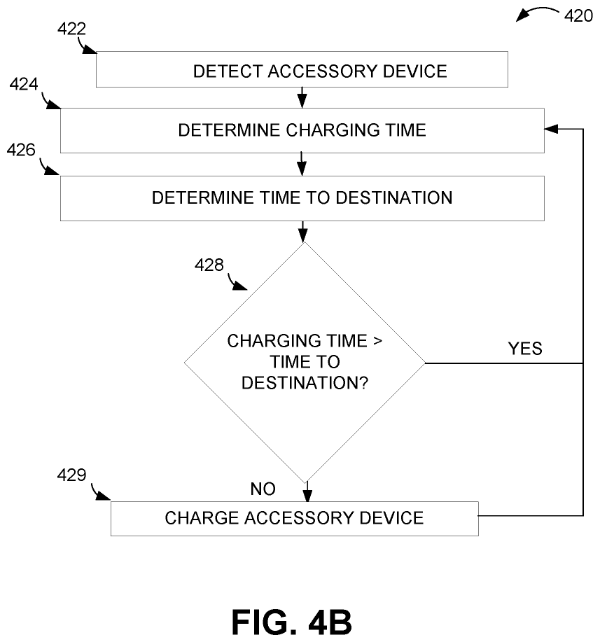

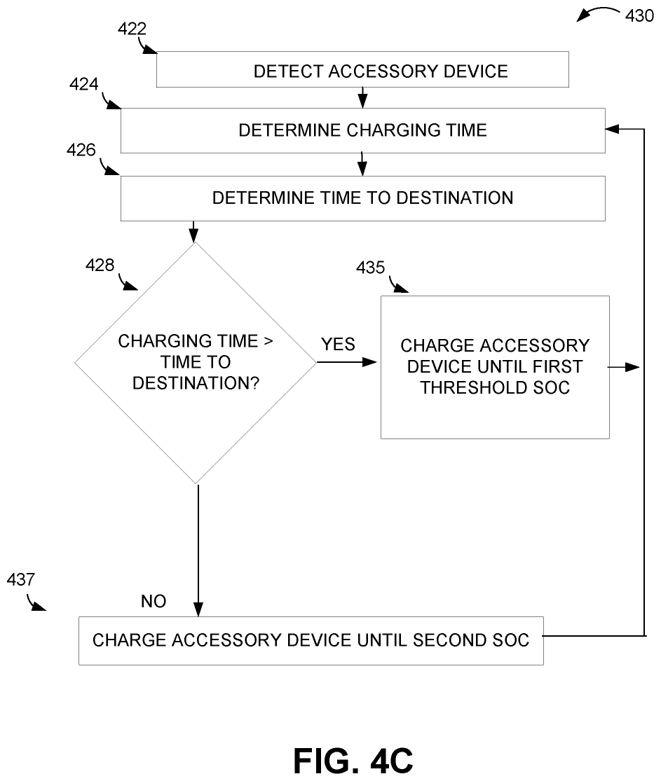

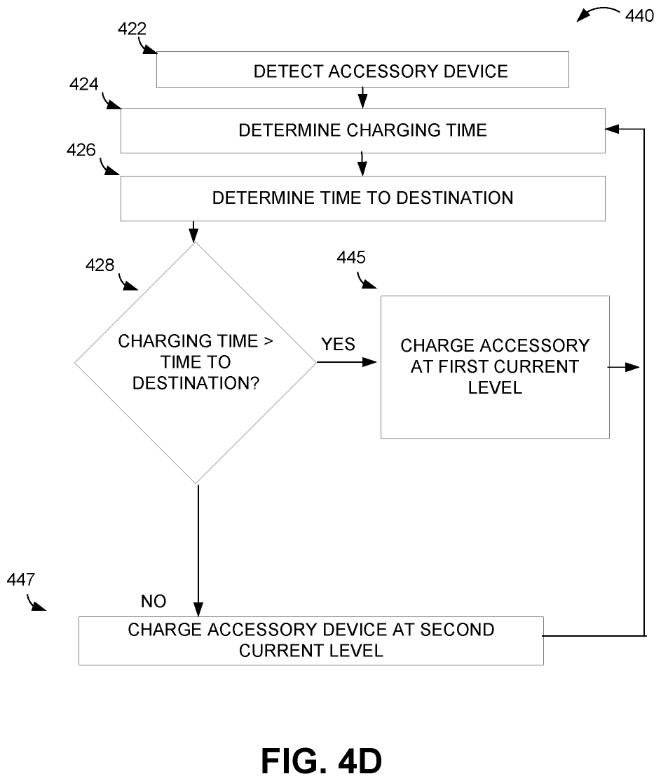

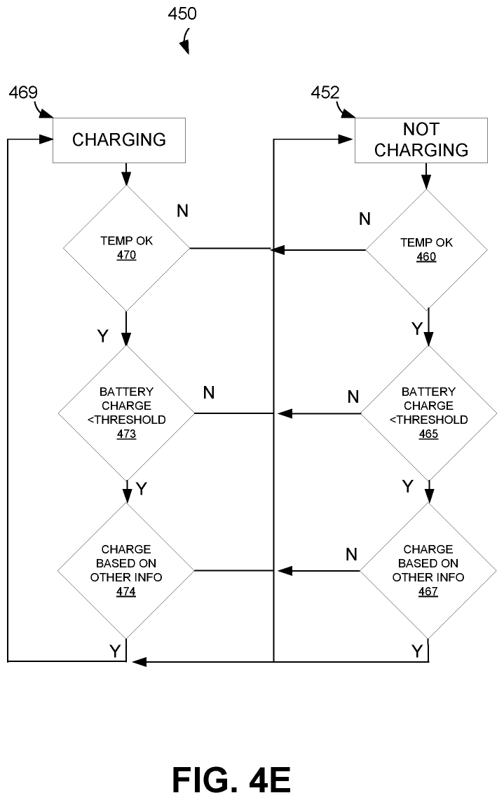

FIGS. 4A-4E show methods 400, 420, 430, 440, and 450 that can be performed at battery charge system 300 (e.g. accessory charge circuit 310 and/or accessory device 315) and/or accessory charge system 200. Methods 420, 430, 440, and 450 include various thresholds which correspond to threshold levels, and not necessarily the same threshold levels. These methods can enable charging of accessory devices according to the specific needs of the battery and/or device, and/or according to vehicle and/or driving specific operational information. These methods can enable charging of accessory devices according to charging profiles based on accessory device, and/or vehicle and/or driving specific operational information as discussed herein. These methods 400, 420, 430, 440, and 450 can correspond to methods for dynamic accessory device charging according to vehicle and/or accessory device specific information. The steps shown are merely non-limiting examples of steps that can be included for performing the method of charging vehicle accessories according to accessory device, and/or vehicle operational information (e.g. vehicle and/or driving specific information). The steps shown in the methods 400, 420, 430, 440, 450, can include and/or be included in one or more circuits or logic described herein. It can be understood that the steps shown can be performed out of order (i.e. a different order than that shown in FIGS. 4A-4E), and with or without one or more of the steps shown. These steps can also repeat, for example for performing of steps according to updated information.

FIG. 4A shows method 400 for charging an accessory based on vehicle and/or driving specific information. Method 400 can include step 402 for detecting an accessory device. Accessory devices can be detected by accessory detection circuit 206 and/or other electrical and/or mechanical means as described herein.

Method 400 can include step 404 for determining accessory device specific information. Determining accessory device specific information can include determining (e.g. retrieving, predicting, and/or calculating) a value for one or more parameters which are specific to the device, it's use, and/or to its battery. These parameters can be battery specific such as battery chemistry, temperature, capacity, thermal capacity, charging cycle, battery voltage, capacity, discharge rate, depth of discharge, etc. These parameters can be device and/or use specific charging parameters, such as life time, temperature, intended cycles, discharge rate, etc. For example, determining accessory device specific information can include determining a value for charging time. Charging time can include the time until the battery reaches a specific SOC (e.g. 75%, 85%, 100%). Determining accessory device specific information can include determining one or more thresholds (such as maximum threshold) SOC to charge the battery of the accessory device to (e.g. 80%, 82.5%, 85%, 95%, 100%). Determining accessory device specific information can include determining a time for charging the device. It is understood that determining accessory device specific information can include sending a command to the accessory device so that the accessory device can provide the information to the battery charge system 300. For example, the accessory device can determine this information by sensors 182 as shown in FIG. 3, or another information source 330.

The accessory device information can be determined based on communication with the accessory device (e.g. by accessory charge circuit 210 or 310). The accessory device information can be determined based on identification of the accessory device (such as based on model number, serial number, etc.). The accessory device information can be determined by one or more sensors of accessory charge circuit 210. This information can be retrieved from information source 330 (i.e. it can be an input or information source 330 for battery charging system 300). The accessory device information can be retrieved from one or more memory (such as memory 208). It is understood that the accessory charge circuit 210 can store information about the accessory device and/or charging to determine accessory device information. For example, the number of time the system 300 was used to charge the device can relate to the charging cycles of the device. As another example, information on if the device is used during the navigation of the vehicle can relate to the time for charging the device. In other words device specific information and the charging time for the device can depend on a prediction of the use of the device. Accessory device specific information can be stored in memory and can be occasionally be updated. As an example, the system 300 can update the information if the device 315 was used during charging (i.e. if there was a drain or load on the battery). The system can also determine various correlations between accessory device specific information and/or vehicle specific information (for example to determine if the accessory device 315 was used, and when, while the vehicle was in motion). For example, the system can store information related to device usage according to specific vehicle, driver/occupant, environment, and/or driving information. For example, the driver and/or occupant profile information can correspond to the driver and/or occupant's use of the device. For example, this information can include information on if, how often, and/or on what routes or segments the occupant or driver uses the device. This information can include information on if, how often, and/or on what routes or segments the occupant or driver disconnects the accessory device, and/or charges it. For example, the profile can include information corresponding to if the driver uses the device at specific stops, etc.

As previously discussed, vehicle operational information can be an information source 330 for the battery charging system 300. Accordingly, method 400 can include step 406 for determining vehicle and/or driving operational information. This can include vehicle and/or driving specific information as disclosed herein. For example, this can include information from information source 330 shown in FIG. 3, and/or vehicle systems 258, and/or sensors 120 as shown in FIG. 2. As non-limiting examples, the vehicle operational information can include a destination, waypoints, the expected time to destination, the expected speed, velocities of the vehicle until the destination, the number of turns, stops, etc. Vehicle operational information can also include information about the driver (such as driving habits, driving risk profiles, frequent driving routes, destinations, waypoints, driving habits, their use of the device during driving, etc.). Vehicle operational information can be learned, inferred, predicted, and/or real-time information. For example, it can include information regarding if the vehicle is navigating a usual route (e.g. work commute), or a new route, and/or a deviation from that usual route. The information can include expected or actual vehicle performance information, expected or actual vehicle battery levels. For example, if the fuel or vehicle battery SOC is below a threshold that would not allow the vehicle to arrive at a destination, the information can include an indication that a deviation from a route is expected (for example for refueling or recharging).

Method 400 can include step 408 for determining a charging profile (i.e. one or more charging parameters according to which charging is performed). The charging profile can be determined based on the accessory device specific information (i.e. that determined at step 404), and/or the vehicle operational information (i.e. that determined at step 406). The charging profile can include one or more voltages, current, SOC, and/or times for charging. The charging profile can be dynamic, in that it can be adapted based on one or more conditions or logical checks disclosed herein. As an example, if the time to a destination is determined to be greater than a time to charge the device (i.e. to a specific SOC), the current or charging rate can be set so that the device charges to a specific SOC (e.g. 80%, 90%, 95%, or 100%) by the time the vehicle arrives to a destination. Alternatively or in addition, charging can be deferred to a later point in time (i.e. a charging rate is set to zero or another rate, and then non-zero or an increased rate at a later point in time). As such, charging the accessory device can be deferred until a predicted time to a destination less the determined charging time. It is understood that charging profiles can be dynamic and aspects of charging vary according to vehicle and/or device specific information or parameters.

In some embodiments, aspects of the charging profile can be varied depending on an expected time or arrival to a destination, an actual or expected use of the vehicle battery or power source 211 SOC (i.e. it can vary depending on an expected use of the battery or power source 211 for charging of the device 315, and/or for powering the vehicle, and/or regeneration), and/or a use of the device until the vehicle arrives to the destination. For example, the system 300 or 200 may determine aspects of the charging profile based on accessory device specific information and vehicle operational information that corresponds to a determination that the device may be used (and thus battery is drained) while the vehicle is stopped and/or is below a certain speed. As a further example, the charging profile can depend on the route (such as a commute) of the vehicle, and a determination that the accessory device is not usually removed from the charger during that specific route (e.g. at least 50%, 55%, 60%, 85%, 90% of the time that route is taken). A commute route can be one that is determined to be frequently repeated, for example one a week, twice a week, etc. For example, the charging profile can dictate that the device is charged to a specific threshold SOC (such as 80%, 85%, 90%).

As other examples, the charging profile can be determined so that arrival at the destination and/or to a waypoint with a vehicle battery and/or power source 211 SOC at or above a threshold is prioritized over charging of the accessory device. It is understood that the charging profile can encompass a specific time interval or duration until the device 315 battery reaches a specific SOC threshold.

In embodiments, the charging profile is determined based on the specific needs of the battery of the accessory device in view of vehicle and/or driving specific information. For example, the lifespan of the battery may be maximized by only charging, the device until a specific threshold SOC (e.g. 80%), until right before the battery is expected to be used (i.e. during the vehicle operation, and/or at a destination), upon which the battery can be charged to a second threshold (e.g. 100%). An another example, the charging profile can allow for trickle charging and/or maintenance of the battery, until before an expected use of the battery. There thresholds can depend on driver and/or occupants specific information. For example, driving (e.g. commuting) habits, device use habits (e.g. tendencies to remove the device from the vehicle charging apparatus). In embodiments, if habits of the driver and/or occupant are not known, a default charging profile to charge until default threshold SOC (e.g. 100%) could be set for new drivers and/or occupants until more information is learned about their driving (e.g. commuting) habits, device use habits (e.g. tendencies to remove the device from the vehicle charging apparatus).

Method 400 can include step 410 for charging the accessory device based on the determined charging profile (i.e. the charging profile determined at step 408). It is understood that steps of method 400 can repeat and/or can overlap (i.e. can be performed in parallel). For example, the method can resume at step 402, 404, 406, and/or 508 after performing step 410.

It is understood that various inputs and/or information (e.g. accessory device specific information at step 404 and vehicle operational information at step 406) can be continuously determined, and the battery charging system 300 can charge the accessory (or not) based on that information.

FIG. 4B shows another method 420 for charging an accessory device based on vehicle and/or driving specific information. Method 420 can generally correspond to an implementation for delaying charging. Method 420 can include step 422 for detecting the accessory device. The accessory device can be detected as discussed with reference to accessory detection circuit 206. Method 420 can include step 424 for determining a charging time for the accessory device. The charging time can depend on a number of accessory device, vehicle and/or driving specific information as previously discussed.

As previously discussed, one or more inputs can be used in determining and/or predicting a time when the device is to be used. This can include a time to a destination. As such, method 420 can include step 426 for when the device is to be used, and/or determining a time to a destination. This step can be performed in view of vehicle and/or driving specific information as discussed herein.

Method 420 can include step 428 for comparing the charging time to the time the device is expected to be used. For example, if the device is to be used at a destination, method 420 can include step 428 for comparing the charging time to the time to the destination (e.g. as determined at steps 424 and 426). Step 428 can include determining that the charging time is greater than or equal to the time to a destination.

If the charging time is greater than or equal to the time to a destination, method 420 can resume determining or recalculating the charging time and/or the time to a destination at steps 424 and/or steps 426. If the charging time is less than or equal to the time to a destination, the method 420 can move on to step 429 for charging the accessory device. If the charging time is not greater than or equal to the time to the destination, the method 420 can move on to step 429 for charging the accessory device. At step 429, the accessory device can be charged according to a charging profile as described herein. The method 420 can continuously determine charging time and/or time to destination as shown in steps 424 and/or step 426. As such, after step 429, 420 can resume to step 424 and/or step 428.

Method 420 can include step 428 for comparing the charging time to the time to the destination (e.g. as determined at steps 424 and 426). Step 428 can include determining that the charging time is greater than or equal to the time to a destination. If the charging time is greater than or equal to the time to a destination, method 420 can resume determining or recalculating the charging time and/or the time to a destination at steps 424 and/or steps 426. If the charging time is less than or equal to the time to a destination, the method 420 can move on to step 429 for charging the accessory device. If the charging time is not greater than or equal to the time to the destination, the method 420 can move on to step 429 for charging the accessory device. At step 429, the accessory device can be charged according to a charging profile as described herein. The method 420 can continuously determine charging time and/or time to destination as shown in steps 424 and/or step 426. As such, after step 429, 420 can resume to step 424 and/or step 428.

FIG. 4B shows another method 420 for charging an accessory device based on vehicle and/or driving specific information. Method 420 can generally correspond to an implementation for delaying charging. Method 420 can include step 422 for detecting the accessory device. The accessory device can be detected as discussed with reference to accessory detection circuit 206. Method 420 can include step 424 for determining a charging time for the accessory device. The charging time can depend on a number of accessory device, vehicle and/or driving specific information as previously discussed.

As previously discussed, one or more inputs can be used in determining and/or predicting a time to a destination. Method 420 can include step for determining a time to a destination. This step can be performed in view of vehicle and/or driving specific information.

FIG. 4C shows another method 430 for charging a battery of an accessory to a vehicle according to aspects of the present disclosure. Method 430 can include step 422 to step 428 as previously discussed with reference to FIG. 4B and method 420.

In method 430, if at step 428 it is determined that the charging time is greater than or equal to the time to a destination, method 430 can then perform step 435 for charging the accessory until a first threshold SOC. The method 430 can resume determining or recalculating the charging time and/or the time to a destination at steps 424 and/or steps 426.

In method 430, if at step 428 it is determined that the charging time is less than (or equal) to the time to a destination method 430 can then perform step 437 for charging the accessory until a second threshold SOC. If the charging time is not greater than or equal to the time to the destination as determined at step 428, the method 420 can move on to step 437 for charging the accessory device until a second SOC. The method 420 can continuously determine charging time and/or time to destination as shown in steps 424 and/or step 426. As such, after step 429, method 430 can resume to performing step 424 and/or step 428.

FIG. 4D shows another method 440 for charging a battery of an accessory to a vehicle according to aspects of the present disclosure. Method 440 can include step 422 to step 428 as previously discussed with reference to FIG. 4B and method 420.

In method 440, if at step 428 it is determined that the charging time is greater than or equal to the time to a destination, method 430 can then perform step 445 for charging the accessory at a first current level. For example, step 445 can correspond to trickle charging the accessory device. It is also understood that that the accessory can be charged until a specific threshold SOC. The method 440 can resume determining or recalculating the charging time and/or the time to a destination at steps 424 and/or steps 426.

In method 440, if at step 428 it is determined that the charging time is less than (or equal) to the time to a destination method 440 can then perform step 447 for charging the accessory at a second current level. Step 447 can correspond to charging the device right before the battery is expected to be used. It can also be understood that if the charging time is not greater than or equal to the time to the destination as determined at step 428, the method 440 can move on to step 447 for charging the accessory device at a second current level. It is also understood that the accessory can be charged until a specific threshold SOC. The method 440 can continuously determine charging time and/or time to destination as shown in steps 424 and/or step 426. As such, after step 447, step 424 and/or step 428 can be performed.

FIG. 4E shows another method 450 for charging a battery of an accessory to a vehicle according to aspects of the present disclosure. As disclosed herein, charging the accessory device can depend on various vehicle and/or accessory device specific information. As such, method 450 can include various logical checks for toggling between two states, charging and not charging. Method 450 can include various logical checks for toggling between two states, charging and not charging depending on vehicle and/or accessory device specific information. Method 450 can be performed after detecting an accessory device that may require charging as disclosed herein. Method 450 can include step 452 that corresponds to a state of not charging the device. Method 450 can include step 460 for determining if the temperature of the accessory device is at an optimal level, (i.e. within, at, above, or below one or more thresholds). If the temperature of the accessory device is not at an optimal level, the method can remain in the not charging state as shown in step 452. If yes, method 450 can include step 465 for determining that the battery charge (e.g. a SOC) is at or below a threshold. In not, the method can remain in the not charging state as shown in step 452. If at step 465 it is determined that the battery charge (e.g. a SOC) is at or below a threshold, the method 450 can perform step 467 for determining that the device should be charged based on comparisons to one or more other information. Step 467 can correspond to determining that the one or more vehicle and/or driving specific information as disclosed herein meets and/or passes a logical check, compares to a threshold as disclosed herein. For example, this can include determining that the battery should be charged if the time to destination is less than the time to charge as disclosed herein. As another example, this step 467 can be based on comparing one or more inputs from information source 330 to a threshold. If the determination is yes that the device should be charged based on other information, method 450 can perform step 469 for charging the accessory device.

Method 450 can include step 470, similar to step 460, for determining if the temperature of the accessory device is at an optimal level (i.e. within, at, above, or below one or more thresholds). If no, the method 450 can shift to the not charging state as shown in step 452. If yes, method 450 can include step 473, which similar to step 465, determines that the battery charge (e.g. a SOC) is at or below a threshold. In not, the method 450 can shift to the not charging state as shown in step 452. If at step 473 it is determined that the battery charge (e.g. a SOC) is at or below a threshold, the method 450 can perform step 474, similar to step 476 for charging based on comparisons to one or more other information.

As used herein, the terms circuit, system, and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a vehicle, a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability. For example, computing component might be found in components making up vehicle 100, accessory charging system 200, accessory charge circuit 210, computing system 110, ECU 125, and/or accessory device 315.

Computing component 500 might include, for example, one or more processors, controllers, control components, or other processing devices. Processor 504 might be implemented using a general-purpose or special-purpose processing engine such as, for example, a microprocessor, controller, or other control logic. The processor might be specifically configured to execute one or more instructions for execution of logic of one or more circuits described herein, such as accessory charge circuit 210, control circuit 212, detection circuit 206, and/or logic for control systems 130. Processor 504 may be configured to execute one or more instructions for performing one or more methods 400, 420 and/or 450.

Processor 504 may be connected to a bus 502. However, any communication medium can be used to facilitate interaction with other components of computing component 500 or to communicate externally. In embodiments, processor 504 may fetch, decode, and/or execute one or more instructions to control processes and/or operations for enabling vehicle servicing as described herein. For example, instructions can correspond to steps for performing one or more steps of method 400 shown in FIG. 4A.

Computing component 500 might also include one or more memory components, simply referred to herein as main memory 508. For example, random access memory (RAM) or other dynamic memory, might be used for storing information and instructions to be fetched, decoded, and/or executed by processor 504. Such instructions may include one or more instructions for execution of methods 400, 420, 450, and/or for execution of one or more logical circuits described herein. Instructions can include instructions 209, and/or 108 as described herein, for example. Main memory 508 might also be used for storing temporary variables or other intermediate information during execution of instructions to be fetched, decoded, and/or executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communication port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method executed at a processor of a vehicle, comprising:
determining a charging time for an accessory to a vehicle based on anticipated demand of the accessory device;
determining vehicle operational information comprising driving characteristics; and
dynamically charging the accessory device based on the determined vehicle operational information and the charging time for the accessory to the vehicle.

2. The method of claim 1, further comprising determining accessory device specific information and charging the accessory device according to a need of the accessory device.

3. The method of claim 1, wherein the vehicle operational information further comprises at least one of vehicle specific information, contextual information related to the vehicle, or driver specific information.

4. The method of claim 3, wherein the accessory device is charged based on an estimated use of the accessory device by a specific driver or occupant of the vehicle.

5. The method of claim 4, wherein charging the accessory device based on the determined vehicle operational information and the charging time for the accessory to the vehicle comprises charging the accessory device based on a determined route.

6. The method of claim 1, wherein the vehicle operational information comprises an estimated arrival time at which the vehicle will arrive at a destination.

7. The method of claim 6, further comprising:
determining that the charging time for the accessory to the vehicle is less than or equal to an estimated time to the destination, and charging the accessory device.

8. The method of claim 6, further comprising determining that the charging time for the accessory to the vehicle is greater than or equal to an estimated time to the destination, and not immediately charging the accessory device.

9. The method of claim 6, further comprising determining that the charging time for the accessory to the vehicle is greater than or equal to an estimated time to the destination and charging the accessory device to a first state of charge threshold.

10. The method of claim 9, further comprising determining that the charging time for the accessory to the vehicle is less than an estimated time to the destination and charging the accessory device to a second state of charge threshold.

11. The method of claim 1, wherein charging the accessory based on the determined vehicle operational information comprises deciding to defer charging the accessory until a predicted time to a destination less the determined charging time.

12. The method of claim 1, wherein determining a charging time for an accessory to a vehicle comprises determining a predicted use of the accessory device.

13. The method of claim 13, further comprising:
detecting that the vehicle is traversing a route previously traversed;
determining that the accessory device is not usually removed from the charger during that specific route, and
charging the device to a state of charge threshold while the vehicle is on that route.

14. The method of claim 1, wherein the device is only charged if the state of charge of a battery of the vehicle that is used to charge the accessory device is at or above a threshold.

15. The method of claim 1, wherein the accessory device is only charged a temperature of the accessory device is below a temperature threshold.

16. The method of claim 15, wherein the accessory device is only charged if a state of charge of a battery of the accessory device is below a state of charge threshold.
